(19) United States
(12) Patent Application Publication
(10) Pub. No.: US 2015/0106137 A1
(43) Pub. Date: Apr. 16, 2015

(54) Enhanced Content Delivery Systems and Methods

(71) Applicant: MASTERCARD INTERNATIONAL INCORPORATED, Purchase, NY (US)

(72) Inventors: Ian Slater, London (GB); Menno Dellisse, Uccle (BE)

(21) Appl. No.: 14/515,073

(22) Filed: Oct. 15, 2014

(30) Foreign Application Priority Data
Oct. 16, 2013 (GB) 1318345.4

(51) Int. Cl. G06Q 30/02; G06Q 10/02

(52) U.S. Cl. CPC G06Q 30/0269; G06Q 10/02; G06Q 30/0261
USPC 705/5; 705/14.66; 705/14.58

(57) ABSTRACT

A method of distributing an offer to a user, the method being implemented on a processor, and the method comprising: receiving information associated with the user; receiving information associated with travel plans of the user; determining an offer from a database comprising a plurality of offers, wherein each of the plurality of offers comprises an offer identifier, and wherein the offer is determined based on the information associated with the user and the information associated with the travel plans; providing the offer identifier associated with the determined offer to the user.

### FIELD

The present disclosure generally relates to enhanced content delivery systems and methods, and in particular but not exclusively to distributing content via a distribution network. In one example, additional services relevant to a user of the distribution network may be distributed via an offer terminal. In a further example, additional services relevant to a user of the distribution network may be distributed via a mobile telecommunications device.

### BACKGROUND

Within the travel sector a global distribution system (GDS) is a distributed network that enables transactions between vendors, e.g. airlines, hotels and car rental firms, and booking/travel agents in order to allow end users (via the agents) to be provided with travel related services.

Within a GDS system, real-time links are maintained to the vendors' databases and during a travel reservation the GDS system will route reservation requests from a travel agent to a computer reservation system (CRS) associated with the vendor in question.

The data returned to the travel agent following a reservation enquiry placed via a GDS system comprises details of the products or services matching or closely approximating the initial enquiry.

It is an aim of the present disclosure to provide an enhanced distribution system for providing additional travel related products and services to end users.

### SUMMARY

The present disclosure describes a method of distributing an offer to a user, the method being implemented on a processor, and the method comprising: receiving information associated with the user; receiving information associated with travel plans of the user; determining an offer from a database comprising a plurality of offers, wherein each of the plurality of offers comprises an offer identifier, and wherein the offer is determined based on the information associated with the user and the information associated with the travel plans; providing the offer identifier associated with the determined offer to the user.

Optionally, providing the offer identifier further comprises providing confirmation of travel plan arrangements.

Optionally, each of the plurality of offers is associated with information associated with users who have previously accepted the offer.

Optionally, the method further comprises receiving payment for the travel plans via a payment transaction comprising transaction data. At least part of the information associated with the user may be received from the transaction data. Further, at least part of the information associated with the travel plans may be received from the transaction data.

Optionally, information associated with the user comprises one or more from a group including: age; age range; gender; nationality; residence; hobbies; marital status; social media profile; and driving licence status.

Optionally, information associated with travel plans comprises one or more from a group including: departure location; arrival location; stopover location; final destination; duration at arrival location; and accommodation preferences.

Optionally, wherein information associated with travel plans of the user is anonymized. Optionally, information associated with the user is anonymized.

Optionally, providing the offer identifier comprises emailing the offer identifier to the user.

Optionally, providing the offer identifier comprises sending the offer identifier to a mobile device of the user. The offer identifier may be sent to an application on the mobile device. The method may further comprise receiving location data from the mobile device, and sending further offer identifiers to the user in dependence on the location data.

Optionally, the offer identifier comprises one or more from a group including: an alphanumeric string; a barcode; and a quick response code.

A non-transitory computer-readable storage medium storing executable computer program instructions may be arranged to implement on a computing device the method.

The present disclosure further describes a payment system for distributing an offer to a user, the system comprising: a database comprising a plurality of offers, wherein each of the plurality of offers comprises an offer identifier; a processor arranged to receive information associated with the user and information associated with travel plans of the user, and determine the offer based on the information associated with the user and the information associated with the travel plans; and an output arranged to provide the offer identifier associated with the determined offer to the user.

The present disclosure further describes an offer engine for determining an offer for a user, the offer engine comprising: a database comprising a plurality of offers, wherein each of the plurality of offers comprises an offer identifier; and a processor arranged to receive information associated with the user and information associated with travel plans of the user, and determine the offer based on the information associated with the user and the information associated with the travel plans.

### DRAWINGS

FIG. 1 is a schematic illustration of a known global distribution system (GDS).

In order that the present disclosure may be more readily understood, specific embodiments of the present disclosure will now be described, by way of non-limiting example only, with reference to the accompanying figures, in which:

FIG. 2 is a schematic illustration of a global distribution system in accordance with an embodiment of the disclosure;

FIG. 3 is a flow chart relating to the operation and interaction with the system shown in FIG. 2.

### DETAILED DESCRIPTION

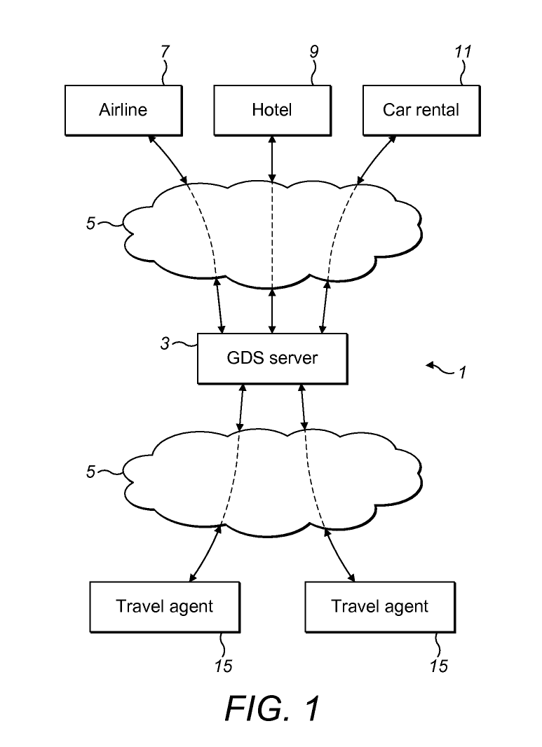

FIG. 1 shows an overview of a known global distribution system 1.

A global distribution system (GDS) server 3 is connected to a network 5, represented by a cloud in FIG. 1, that is in communication with a number of travel vendors' computer systems 7, 9, 11. The network 5 may be a wide area network, local area network, the Internet or other suitable data communications networks.

In the system 1 of FIG. 1, the GDS server 3 is shown to be communication with an airline computer reservation system 7, a hotel computer reservation system 9 and a car rental computer reservation system 11. It is to be appreciated, however, that the GDS may be in communication with a plurality of such systems but, for clarity, only a limited number of such vendor systems are depicted in FIG. 1. It is also noted that the GDS server 3 may be in communication with other types of vendors, e.g. an activities computer reservation system which provides the capability to book activities such as tourist tours, water sport activities, theatre trips, etc.

The GDS server 3 is also in communication with a number of travel agent computer systems 15, two of which are shown in FIG. 1.

In a known method of operation, an end user (e.g. an entity wishing to book travel) would enter a travel agency and request to make a reservation via the travel agent computer system 15. The travel agent would then enter relevant information, such as the end user's details and requested travel type details, into the travel agent's computer system 15 which is in communication with the GDS server 3. It is noted in this respect that the travel agent computer system 15 is effectively a front end user interface for the global distribution system as hosted on the GDS server 3.

The entered relevant information would then be sent to the GDS server 3 via the network 5 which would query the various vendor computer reservation systems 7, 9, 11 for matches or close matches to the end user's requirements. Travel related data matching or closely matching the end user's requirements would then be sent via the GDS server 3 to the travel agent's computer system 15 for further review/completion by the end user of a travel related transaction.

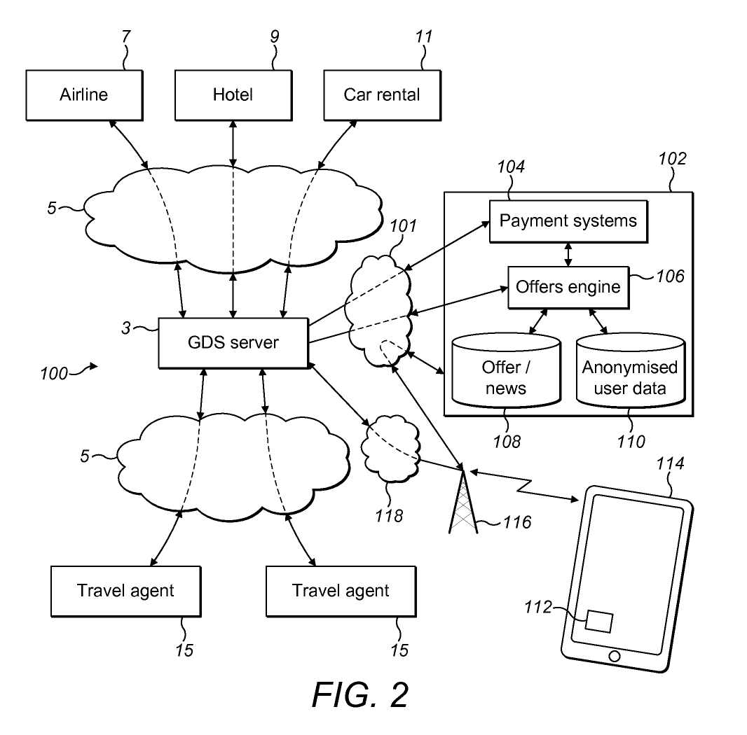

FIG. 2 shows an overview of a system 100 according to an embodiment of the present disclosure.

The system of FIG. 2 comprises the GDS server 3, vendor computer reservation systems 7, 9, 11 and travel agent computer systems 15 of FIG. 1.

Additionally, in FIG. 2, the GDS server 3 is in communication with a payment processing service provider 102 via a network 101 (this could be the same network 5 that connects the vendors to the GDS server and the travel agent computer systems to the GDS server, or it could be a separate network).

A payment provider is arranged to carry out payment transactions between the end user and the vendors. The payment provider comprises a system 102 represented by a single box within FIG. 2. However, in other embodiments, the payment provider may operate a distributed payment network as well as or in addition to the single server system shown in FIG. 2.

The payment provider's system 102 comprises payment processing components 104 to allow end users to complete transactions for travel related services and products offered by the vendors. As shown in FIG. 2, the GDS server 3 is in communication with the payment provider's systems and payment data from an end user's payment means (e.g. contact/contactless integrated circuit cards) is routed via the GDS server 3 to and from the travel agent computer systems 15 and the payment provider's system 102.

The payment provider is further arranged to determine offers associated with the travel details of the end user. Accordingly, the payment provider's system 102 comprises the above mentioned payment processing components 104 and an offer engine 106 that is in communication with one or more databases 108, 110. The offer engine 106 is in communication with an offers database 108 and also an anonymised user data database 110. The offers database 108 comprises a set of current offers or news information that may be relevant to end users interacting with the GDS system via the travel agents computer system 15. The anonymised user data database 110 comprises historical data associating offer type data with anonymised user data (e.g. users aged 25-35 have shown interest in offer types A, B, C, etc.).

The offers engine 106 may either be queried via the payment processing components 104, e.g. as part of a transaction process, or directly from the GDS server 3, e.g. during the process of searching for a suitable travel service/product.

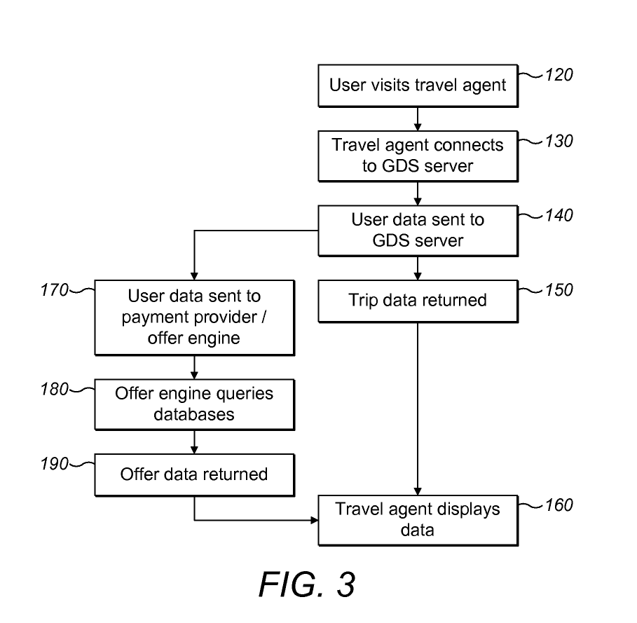

FIG. 3 outlines an overview of a method of interacting with a GDS system 100 in accordance with an embodiment of the present disclosure.

In step 120 an end user visits a travel agent and the agent, in Step 130, connects to the GDS server 3.

In Step 140 the travel agent collects user/travel data required to frame a suitable search for travel products/services and this user/travel data is sent from the agent's computer system 15 to the GDS server 3 which in turn queries the vendor computer reservation systems 7, 9, 11.

In Step 150 the GDS server 3 returns, to the travel agent computer system 15, travel product/service data resulting from searches on the vendors' computer reservation systems.

In Step 160 the travel agent's computer system 15 displays the search results.

As well as using the user/travel data to query the vendors' computer reservation systems 7, 9, 11, the GDS server 3, in step 170 (following step 140), sends user data to the payment provider's system 102 and, in particular, to the offers engine 106. It is noted that the user data may be sent directly to the offers engine 106 by the GDS server 3 or may be sent via the payment processing components 104.

In step 180 the offers engine 106 uses the received user data to query the databases 108, 110. In particular the anonymised user data database 110 returns examples of offer types that end users who share characteristics (e.g. driving licence status, age demographic, marital status, current travel destination, previous travel destinations) with the current end user have previously either acquired through a transaction or have shown an interest in. The returned offer types are then used to retrieve current offers from the offers database 108 that have the same or similar offer characteristics.

In Step 190 the offers engine 106 sends current offer information to the GDS server 3 which forwards the information to the travel agent's computer system 15 which in step 160 displays this information to the travel agent and/or end user.

In an alternative arrangement, an end user may have opted for his personal data to be exchanged with the GDS system 100 for the purposes of receiving more targeted offers/news from the offers engine 106. In such an arrangement, the user may have an online profile that is associated with the unique number on their payment card or payment device and the offers engine 106 may use the online profile to select personalised offers (e.g. based on offers previously accepted by the user and/or personal preferences indicated by the user on the online profile). The online profile may comprise information from social media. The server then sends the relevant personalised offers to the GDS server 3 for onward transmission to the travel agent and display to the user.

Many modifications may be made to the above examples without departing from the spirit and scope of the present disclosure as defined in the accompanying claims.

For example, turning to FIG. 2, the present application may extend to a software application 112 (an “app”) running on a smart device 114 (e.g. a mobile telecommunications device such as an iOS®, Android®, MS Windows@ etc. device). The smart device is wirelessly connected to a cellular network 116 (represented by a cell mast for simplicity), and the cellular network 116 is connected to a network 118 (this could be the same network 5 that connects the vendors to the GDS server and the travel agent computer systems to the GDS server, or it could be a separate network).

The app 112 on the smart device 114 may be configured to receive travel product/service information either directly from the GDS server 3 or independently, e.g. directly from the payment provider's computer system 102.

It is noted that end users will often only book part of their travel requirements at an initial transaction point. For example, an end user may book air flights but defer booking hotel, car hire, activities etc. until closer to their date of travel.

The use of a smart device app 112 that can receive travel services/product information from either the GDS server 3 or the payment provider 102 provides the capability for the user to make additional transactions as they approach their travel date and also during their trip.

The end user may also in a further variation of the disclosure conduct all their travel booking transactions via the smart device 114 and the app 112. Alternatively, the app may be used to book additional products/services once an initial transaction has been made.

The payment provider's system 102 or the GDS server 3 may track a user's travel booking over time and push further offers or travel related news to the end user as the date of travel approaches and even during the period of travel. The pushed information may be geolocalised to the area of travel, e.g. if the user is travelling to New York they may get pushed details of sightseeing trips in New York, theatre events, etc.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty and without departing from the spirit and scope of the disclosure as defined in the appended claims. Thus, the present disclosure is not intended to be limited to the embodiments shown herein, but is to be accorded the widest scope consistent with the principles and novel features disclosed herein.

It should also be appreciated that, as applicable, the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should further be appreciated that one or more aspects of the present disclosure transform a general-purpose computing device into a special-purpose computing device when configured to perform the functions, methods, and/or processes described herein.

What is claimed is:

1. A method of distributing an offer to a user, the method being implemented on a processor, and the method comprising:
receiving information associated with the user;
receiving information associated with travel plans of the user;
determining an offer from a database comprising a plurality of offers, wherein each of the plurality of offers comprises an offer identifier, and wherein the offer is determined based on the information associated with the user and the information associated with the travel plans;
providing the offer identifier associated with the determined offer to the user.

2. The method of claim 1, wherein providing the offer identifier further comprises providing confirmation of travel plan arrangements.

3. The method of claim 1, wherein each of the plurality of offers is associated with information associated with users who have previously accepted the offer.

4. The method of claim 1, further comprising receiving payment for the travel plans via a payment transaction comprising transaction data.

5. The method of claim 4, wherein at least part of the information associated with the user is received from the transaction data.

6. The method of claim 4, wherein at least part of the information associated with the travel plans is received from the transaction data.

7. The method of claim 1, wherein information associated with the user comprises one or more from a group including: age; age range; gender; nationality; residence; hobbies; marital status; social media profile; and driving licence status.

8. The method of claim 1, wherein information associated with travel plans comprises one or more from a group including: departure location; arrival location; stopover location; final destination; duration at arrival location; and accommodation preferences.

9. The method of claim 1, wherein information associated with travel plans of the user is anonymized.

10. The method of claim 1, wherein information associated with the user is anonymized.

11. The method of claim 1, wherein providing the offer identifier comprises emailing the offer identifier to the user.

12. The method of claim 1, wherein providing the offer identifier comprises sending the offer identifier to a mobile device of the user.

13. The method of claim 12, wherein the offer identifier is sent to an application on the mobile device.

14. The method of claim 12, further comprising receiving location data from the mobile device, and sending further offer identifiers to the user in dependence on the location data.

15. The method of claim 1, wherein the offer identifier comprises one or more from a group including: an alphanumeric string; a barcode; and a quick response code.

16. A non-transitory computer-readable storage medium storing executable computer program instructions for implementing on a computing device the method of claim 1.

17. A payment system for distributing an offer to a user, the system comprising:
a database comprising a plurality of offers, wherein each of the plurality of offers comprises an offer identifier;
a processor arranged to receive information associated with the user and information associated with travel plans of the user, and determine the offer based on the information associated with the user and the information associated with the travel plans; and
an output arranged to provide the offer identifier associated with the determined offer to the user.

18. An offer engine for determining an offer for a user, the offer engine comprising:
a database comprising a plurality of offers, wherein each of the plurality of offers comprises an offer identifier; and
a processor arranged to receive information associated with the user and information associated with travel plans of the user, and determine the offer based on the information associated with the user and the information associated with the travel plans.
